(19) United States
(12) Patent Application Publication
(10) Pub. No.: US 2025/0365210 A1
(43) Pub. Date: Nov. 27, 2025

(54) ADJUSTING NETWORK PARAMETERS USING MACHINE LEARNING

(71) Applicant: DISH Wireless L.L.C., Englewood, CO (US)

(72) Inventor: Vineet Tyagi, Highlands Ranch, CO (US)

(21) Appl. No.: 18/672,704

(22) Filed: May 23, 2024

(51) Int. Cl. H04L 41/16; G06N 20/00; H04W 24/08; H04W 28/08

(52) U.S. Cl. CPC H04L 41/16; G06N 20/00; H04W 24/08; H04W 28/0908

(57) ABSTRACT

A method includes executing a machine learning model on a computing system, the computing system operating on a centralized node of a wireless communication network. The method further includes monitoring, using the machine learning model, user plane network traffic associated with a user plane tunnel in the wireless communication network. The method further includes detecting, using the machine learning model, an occurrence of one or more conditions in the user plane network traffic indicative of one or more network issues. The method further includes adjusting, by the computing system, one or more network parameters of the wireless communication network based on detecting the occurrence of the one or more conditions in the user plane network traffic.

### BACKGROUND

One type of cellular network is a Fifth generation (5G) wireless network, although this disclosure may apply to other modern cellular networks, including a 6G wireless network. In a 5G wireless network, a 5G Core Network (5G core) is responsible for managing and routing data traffic, providing various network resources and services, and supporting the core functionalities of the cellular network. Fifth generation (5G) wireless networks have the promise to provide higher throughput, lower latency, and higher availability compared with previous global wireless standards. A combination of control and user plane separation (CUPS) and multi-access edge computing (MEC), which allows compute and storage resources to be moved from a centralized cloud location to the “edge” of a network and closer to end user devices and equipment, may enable low-latency applications with millisecond response times. A control plane (CP) may include a part of a network that controls how data packets are forwarded or routed. The control plane may be responsible for populating routing tables or forwarding tables to enable data plane functions. A data plane (or forwarding plane) may include a part of a network that forwards and routes data packets based on control plane logic. Control plane logic may also identify packets to be discarded and packets to which a high quality of service should apply.

User plane function (UPF) nodes may be located within the core network and be configured to transport IP data traffic (e.g., user plane traffic) between user equipment (UE) and a data network and for handling packet data unit (PDU) sessions with the data network. User plane function or UPF nodes may support the separation of control plane (CP) and user plane (UP) functions in the 5G architecture. This separation allows for independent scaling, flexibility, and deployment of the control and user plane functions. A centralized unit (CU) of a radio access network (e.g., which interacts more directly with the UE) may include a CU user plane (CU-UP) portion. The CU-UP portion may correspond with the centralized unit for the user plane. The CU-UP portion may perform functions related to a user plane, such as user data transmission and reception functions, which includes General Packet Raio Services (GPRS) Tunneling Protocol for the UP (or GTP-U). The GTP-U protocol enables the CU-UP portion to build virtual GTP tunnels between a base station (or gNB) and the UPF node.

### BRIEF DESCRIPTION OF THE DRAWINGS

The present disclosure is illustrated by way of example, and not by way of limitation, in the figures of the accompanying drawings.

FIG. 1A depicts a 5G network including a radio access network (RAN) and a core network according to various aspects of the present disclosure.

FIG. 1B-FIG. 1C depict a radio access network and a core network for providing a communications channel (or channel) between a user equipment and a data network according to various aspects of the present disclosure.

FIG. 2 is a block diagram of an example architecture of a customizable pipeline that supports training, configuring, and deploying of one or more machine learning models according to various aspects of the present disclosure.

FIG. 3 is a sequence diagram of a machine learning component monitoring network traffic and a core network function adjusting network parameters according to various aspects of the present disclosure.

FIG. 4 is a flow diagram of a method for training a machine learning model for adjusting network parameters according to various aspects of the present disclosure.

FIG. 5 is a flow diagram of a method for adjusting network parameters using machine learning according to various aspects of the present disclosure.

FIG. 6A-FIG. 6B depicts a radio access network according to various aspects of the present disclosure.

### DETAILED DESCRIPTION

Technologies for adjusting network parameters using machine learning are described. The following description sets forth numerous specific details, such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

In some cellular networks, GTP tunneling is a mechanism that enables the encapsulation and transmission of mobile data and signaling information across network nodes. This process involves the creation of tunnels between gateway servers and mobile devices, through which user data packets are securely transmitted. These tunnels not only support high-speed data transfer but also allow for mobility management, session management, and network scalability, which help maintain continuous service as users move across different network cells. Thus, GTP-U tunneling plays a role in improving wireless communication reliability, particularly as networks evolve towards 5G and 6G technologies.

In some cases, wireless communication networks may experience issues such as packet loss, latency, and degradation of quality of service (QOS), among other examples. These issues often stem from the complexities of managing and maintaining the integrity of the data packets as they navigate through the numerous layers and sections of the network. For example, packet loss may occur due to errors in data handling or from physical interference that disrupts signal transmission. Latency can be introduced by delays in processing at various network points or due to extended routing paths necessitated by the tunneling process itself. Similarly, QoS can degrade when the network is unable to prioritize traffic effectively under heavy load conditions, often a challenge with the dynamic routing and switching protocols involved in GTP-U tunneling.

The technical ramifications of late diagnoses of these network issues can be substantial. For example, unresolved packet loss or excessive latency can render real-time applications like Voice over Internet Protocol (VOIP) calls or live video streaming practically unusable. Users may experience dropped calls, unresponsive applications, or significantly slowed data retrieval and submission rates, impacting their ability to engage in digital activities. Additionally, chronic latency and packet loss can strain the network resources, leading to cycles of poor performance that are difficult to break without comprehensive network adjustments or upgrades. Therefore, prompt and precise identification and resolution of issues within the GTP-U tunneling process enable sustaining the high-performance standards expected in modern 5G and 6G networks. However, diagnosing these problems early presents several challenges, primarily due to the complexity and scale of modern telecommunications networks. For example, GTP-U tunneling, with extensive use of encapsulation and dynamic routing, often obscures the direct visibility of the path that data packets take, making it difficult to pinpoint the origin of issues like packet loss or latency. Network operators often utilize sophisticated monitoring tools that can analyze vast amounts of data in real-time to detect anomalies that may indicate underlying problems.

Aspects of the present disclosure address the above and other deficiencies by adjusting network parameters using machine learning. A machine learning model may be executed on a computing device, such as a computing device implemented on a core network component of a wireless communication network. The machine learning model may analyze first user plane network traffic associated with a user plane tunnel (such as a GTP-U tunnel) in the wireless communication network. The first user plane network traffic may be historical user plane network traffic. Therefore, analyzing the first user plane network traffic may include analyzing historical user plane network traffic associated with a GTP-U tunnel in the wireless communication network. The machine learning model may determine one or more conditions in the first user plane traffic indicative of one or more network issues. For example, the machine learning model may analyze the first user plane network traffic to identify an increase in traffic volume, an increase in a packet loss rate, an increase in latency, or a decrease in the quality of service in the first user plane network traffic. In one example, the machine learning model may determine that the GTP-U tunnel consistently experiences increased packet loss and increased latency during peak hours, which may be indicative of one or more network issues (such as dropped calls or delayed data services). The machine learning model may be trained using the first user plane network traffic and the one or more conditions in the first user plane network traffic, for example, in order to enable the machine learning model to detect the one or more conditions in other (for example, future) user plane network traffic.

The machine learning model can monitor second user plane network traffic associated with the user plane tunnel. The second user plane network traffic may occur some time after the first user plane network traffic. For example, the second user plane network traffic may be current user plane network traffic or real-time user plane network traffic. The machine learning model may detect an occurrence of the one or more conditions in the second user plane network traffic. For example, the machine learning model may detect an increase in traffic volume, an increase in a packet loss rate, an increase in latency, or a decrease in the quality of service in the second user plane network traffic. A centralized node of the wireless communication network may adjust one or more network parameters based on detecting the occurrence of the one or more conditions in the second user plane network traffic. The one or more network parameters may include one or more core network parameters in the wireless communication network. In some aspects, the centralized node may adjust a timer associated with the user plane tunnel, adjust a threshold associated with the user plane tunnel, allocate one or more resources to the user plane tunnel, perform a load balancing for the second user plane network traffic, or re-route the second user plane network traffic to another user plane tunnel in order to decrease a likelihood of the one or more network issues (such as the dropped calls or delayed data services) in the second user plane network traffic.

Some advantages of the present disclosure include, but are not limited to, training a machine learning model on first user plane network traffic (for example, historical user plane network traffic) associated with a user plane tunnel (such as a GTP-U tunnel), which may enable the machine learning model to determine one or more conditions in the first user plane network traffic indicative of one or more network issues and to detect an occurrence of the one or more conditions in second user plane network traffic (for example, real-time user plane network traffic). Some advantages of the present disclosure include adjusting one or more network parameters based on detecting the one or more conditions in the user plane network traffic. Adjusting network parameters in this way may enable one or more components of the wireless communication network (such as a core network function of the wireless communication network) to pre-emptively adjust timer values, adjust threshold values, allocate resources, perform load balancing, or re-route traffic, among other examples, in order to reduce a likelihood of the occurrence of network issues. These and other advantages that would be apparent to those skilled in the art will be apparent from the following more detailed discussion.

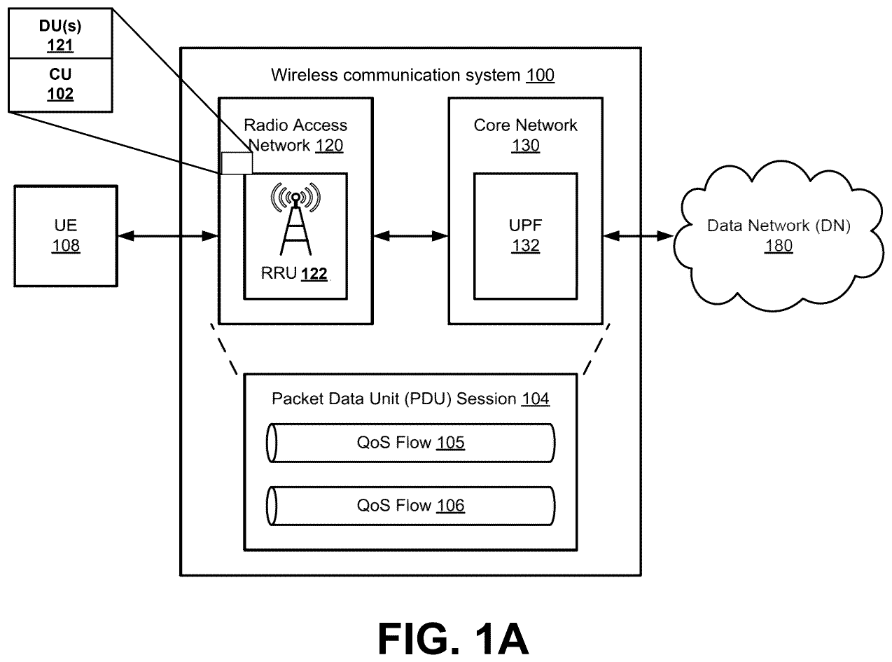

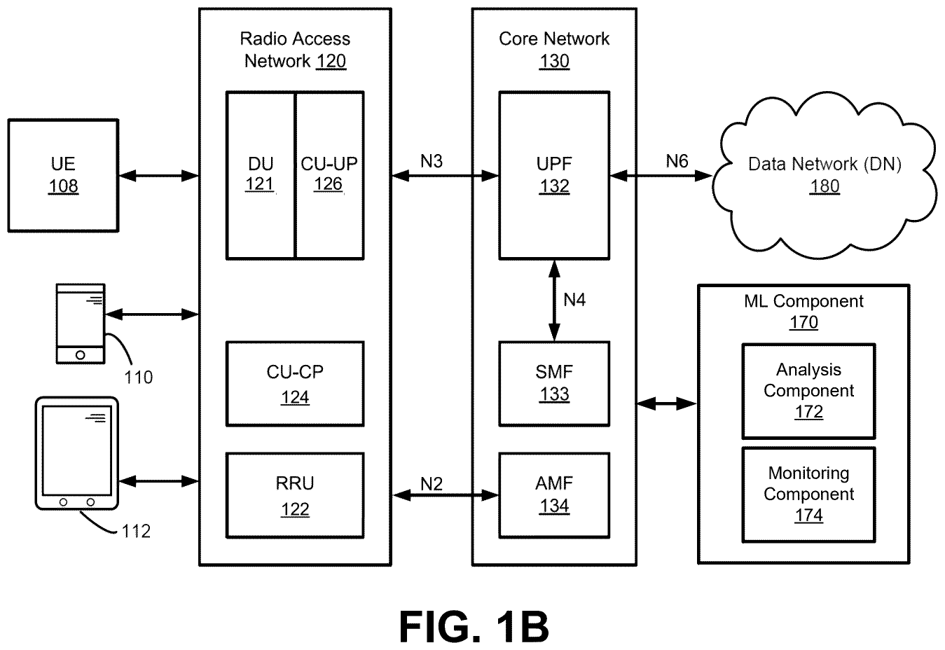

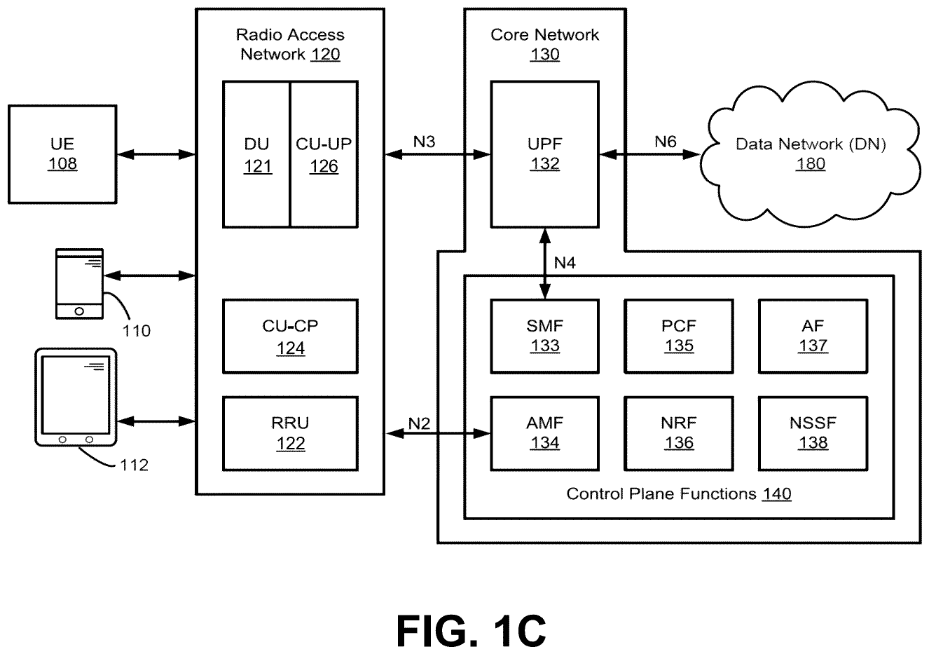

FIG. 1A depicts a wireless communication network 100 including a radio access network (RAN) 120 and a core network 130 according to at least one embodiment. The wireless communication network 100 may be, may include, or may be included in a 5G network. The RAN 120 can include a new-generation radio access network (NG-RAN) that uses the 5G new radio interface (NR). The wireless communication network 100 connects user equipment (UE) 108 to the data network (DN) 180 using the RAN 120 and the core network 130. The data network 180 can include the Internet, a local area network (LAN), a wide area network (WAN), a private data network, a wireless network, a wired network, or a combination of networks. The UE 108 can include an electronic device with wireless connectivity or cellular communication capability, such as a mobile phone 110 or handheld computing device 112. In at least one example, the UE 108 can include a 5G smartphone or a 5G cellular device that connects to the RAN 120 via a wireless connection. The UE 108 can include one of a number of UEs not depicted that are in communication with the RAN 120. The UEs may include mobile and non-mobile computing devices. The UEs may include laptop computers, desktop computers, an Internet-of-Things (IoT) devices, and/or any other electronic computing device that includes a wireless communications interface to access the RAN 120.

In at least some aspects, the RAN 120 includes one or more distributed units (DU(s)) 121, a central unit (CU) 102, and a remote radio unit (RRU) 122 for wirelessly communicating with UE 108. In some aspects, the DU(s) 121 and the CU 102 of the RAN 120 may be co-located with the RRU 122. In other aspects, the DU(s) 121, and the remote radio unit (RRU) 122 may be co-located at a cell site and the CU 102 may be located within a local data center (LDC) that is in close proximity to the cell site.

In aspects, the split DU/CU architecture may provide flexibility, scalability, and efficiency in network deployment and operation. For example, each DU 121 may handle the real-time, lower-layer aspects of baseband processing, including the lower layer of the protocol stack, acting as intermediary between the CU 102 and the RRU 122. The DU 121 functionality may include physical layer (PHY) functions such as error correction, modulation/demodulation, and forward error correction (FEC). These DUs 121 may be responsible for dynamic radio resource management tasks, including scheduling of user data, allocation of radio resources, power control, and interference management, all towards optimizing the performance and efficiency of the radio access network.

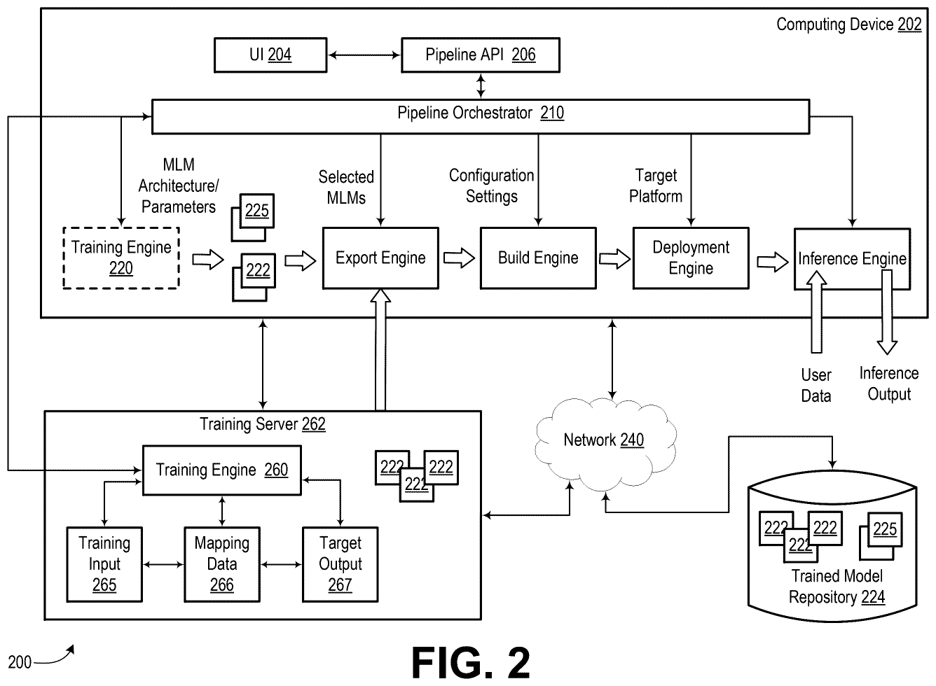

In at least some aspects, the CU 102 may communicate with the core network 130 and include a CU user plane (CU-UP) logical node and a CU control plane (CU-CP) logical node, as will be discussed in more detail with reference to FIGS. 2B-2C. The CU 102 may handle control plane functions of the RAN 120, managing signaling between the UE 108 and the core network 130. This includes session management, mobility management, and establishing bearers (data channels). Although the CU 102 is primarily focused on control plane functions, in some architectures, the CU 102 may also handle aspects of user plane processing, such as packet routing and forwarding, especially in architectures where the CU and DU functionalities are integrated to some extent. The CU 102 may also serve as the interface point to the 5G Core Network (5GC) through the N2 interface for control plane messages and the N3 interface for user plane data, depending on the architecture and deployment.

In various aspects, the CU 102 manages the mobility as users move across different cells or as they transition between different RAN technologies (e.g., from 5G NR to LTE). The CU 102 may be responsible for establishing, modifying, and releasing sessions and bearers for the UE 108, coordinating resources across the RAN 120 to ensure quality of service (QOS) requirements are met. The CU 102 may also play a role in executing security protocols for the RAN 120, including key management for encryption and integrity protection of the signaling and user data. With network slicing being a central feature of 5G, the CU 102 can manage the control plane aspects of network slices within the RAN 120, ensuring that slice-specific requirements for performance, latency, and reliability are met. In addition to interfacing with the core network, the CU 102 may also communicate with other RAN components, such as other CUs and DUs, for functions like load balancing, inter-cell handover, and dual connectivity.

The RRU 122 can include a Radio Unit (RU) and may include one or more radio transceivers for wirelessly communicating with UE 108. The remote radio unit (RRU) 122 may include circuitry for converting signals sent to and from an antenna of a Base Station into digital signals for transmission over packet networks. The RAN 120 may correspond with a 5G radio Base Station that connects user equipment to the core network 130. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 108.

The core network 130 may utilize a cloud-native service-based architecture (SBA) in which different core network functions (e.g., authentication, security, session management, and core access and mobility functions) are virtualized and implemented as loosely coupled independent services that communicate with each other, for example, using HTTP protocols and APIs. In some cases, control plane (CP) functions 140 (FIG. 1C) may interact with each other using the service-based architecture. In at least one embodiment, a microservices-based architecture in which software is composed of small independent services that communicate over well-defined APIs may be used for implementing some of the core network functions. For example, CP network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The primary core network functions can include the access and mobility management function (AMF), the session management function (SMF), and a user plane function (UPF) node, all of which may provide user session capability and user data. The UPF (e.g., UPF node 132) may perform packet processing including routing and forwarding, quality of service (QOS) handling, and packet data unit (PDU) session management. The UPF node 132 may serve as an ingress and egress point for user plane traffic and provide anchored mobility support for user equipment. For example, the UPF node 132 may provide an anchor point between the UE 108 and the data network 180 as the UE 108 moves between coverage areas. The AMF may act as a single-entry point for a UE connection and perform mobility management, registration management, and connection management between a data network and UE. The SMF may perform session management, user plane selection, and IP address allocation.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 120, such as the DUs 121 and the CU 101, may need to be deployed at a cell site or in an LDC that is in close proximity to a cell site such that the latency requirements are satisfied (e.g., such that the one-way latency from the cell site to the DU component or CU component is less than ˜1.2 milliseconds (ms)).

The wireless communication network 100 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the wireless communication network 100. In some cases, the wireless communication network 100 may support customized policy configuration and enforcement between network slices per service level agreements (SLAs) within the RAN 120. User equipment, such as UE 108, may connect to multiple network slices at the same time (e.g., eight different network slices). In one embodiment, a PDU session, such as PDU session 104, may belong to only one network slice instance. In some cases, the wireless communication network 100 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

The core network 130 may include a set of network elements that are configured to offer various data and telecommunications services to subscribers or end users of user equipment, such as UE 108. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine (VM). A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some aspects, applications and services may be run using virtual machines instead of containers in order to improve security. A common virtual machine may also be used to run applications and/or containers for a number of closely related network services.

The wireless communication network 100 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

As depicted in FIG. 1A, the core network 130 includes a user plane function (UPF) node 132 for transporting IP data traffic (e.g., user plane traffic) between the UE 108 and the data network 180 and for handling PDU sessions with the data network 180. The UPF node 132 can include an anchor point between the UE 108 and the data network 180. The UPF node 132 may be implemented as a software process or application running within a virtualized infrastructure or a cloud-based compute and storage infrastructure. The wireless communication network 100 may connect the UE 108 to the data network 180 using a PDU session 104, which can include part of an overlay network.

The PDU session 104 may utilize one or more quality of service (QOS) flows, such as QoS flows 105 and 106, to exchange traffic (e.g., data and voice traffic) between the UE 108 and the data network 180. The one or more QoS flows can include the finest granularity of QoS differentiation within the PDU session 104. The PDU session 104 may belong to a network slice instance through the wireless communication network 100. To establish user plane connectivity from the UE 108 to the data network 180, an AMF that supports the network slice instance may be selected and a PDU session via the network slice instance may be established. In some cases, the PDU session 104 may be of type Ipv4 or Ipv6 for transporting IP packets. The RAN 120 may be configured to establish and release parts of the PDU session 104 that cross the radio interface.

The RAN 120 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 108, over a geographic area. Some cells may correspond with stationary coverage areas and other cells may correspond with coverage areas that change over time (e.g., due to movement of a mobile RRU).

In some cases, the UE 108 may be capable of transmitting signals to and receiving signals from one or more RRUs within the network of cells over time. One or more cells may correspond with a cell site. The cells within the network of cells may be configured to facilitate communication between UE 108 and other UEs and/or between UE 108 and a data network, such as data network 180. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 fect). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

Referring to FIG. 1A, the UPF node 132 may be responsible for routing and forwarding user plane packets between the RAN 120 and the data network 180. Uplink packets arriving from the CU-UP of the RAN 120 may use a general packet radio service (GPRS) tunneling protocol (or GTP) to reach the UPF node 132. The GPRS tunneling protocol for the user plane (GTP-U) may support multiplexing of traffic from different PDU sessions by tunneling user data over the interface between the RAN 120 and the UPF node 132.

The UPF node 132 may remove the packet headers belonging to the GTP tunnel before forwarding the user plane packets towards the data network 180. As the UPF node 132 may provide connectivity towards other data networks in addition to the data network 180, the UPF node 132 ensures that the user plane packets are forwarded towards the correct data network. Each GTP tunnel may belong to a specific PDU session, such as PDU session 104. Each PDU session may be set up towards a specific data network name (DNN) that uniquely identifies the data network to which the user plane packets should be forwarded. The UPF node 132 may keep a record of the mapping between the GTP tunnel, the PDU session, and the DNN for the data network to which the user plane packets are directed.

Downlink packets arriving from the data network 180 are mapped onto a specific QoS flow belonging to a specific PDU session before forwarded towards the appropriate RAN 120. A QOS flow may correspond with a stream of data packets that have equal quality of service (QOS). A PDU session may have multiple QoS flows, such as the QoS flows 105 and 106 that belong to PDU session 104. The UPF node 132 may use a set of service data flow (SDF) templates to map each downlink packet onto a specific QoS flow. The UPF node 132 may receive the set of SDF templates from a session management function (SMF), such as the SMF 133 depicted in FIG. 1B, during setup of the PDU session 104. The SMF may generate the set of SDF templates using information provided from a policy control function (PCF), such as the PCF 135 depicted in FIG. 1C. The UPF node 132 may track various statistics regarding the volume of data transferred by each PDU session, such as PDU session 104, and provide the information to an SMF.

FIG. 1B depicts a RAN 120 and a core network 130 for providing a communications channel (or channel) between user equipment and data network 180 according to at least one embodiment. The communications channel can include a pathway through which data is communicated between the UE 108 and the data network 180. The user equipment in communication with the RAN 120 includes UE 108, mobile phone 110, and mobile computing device 112. The user equipment may include a set of electronic devices, including mobile computing device and non-mobile computing device.

The core network 130 includes network functions such as an access and mobility management function (AMF) 134, a session management function (SMF) 133, and a user plane function (UPF) node 132. The AMF may interface with user equipment and act as a single-entry point for a UE connection. The AMF may interface with the SMF to track user sessions, to include authenticate the UE 108, assign the UE 108 an IP address, and create a session for the UE 108. The AMF may interface with a network slice selection function (NSSF) (not depicted) to select network slice instances for user equipment, such as UE 108. When a UE is leaving a first coverage area and entering a second coverage area, the AMF 134 may be responsible for coordinating the handoff between the coverage areas whether the coverage areas are associated with the same radio access network or different radio access networks. The SMF 133 may also manage security of the UE 108 and ensure that user data is protected.

The UPF node 132 may transfer downlink data received from the data network 180 to user equipment, such as UE 108, via the RAN 120 and/or transfer uplink data received from user equipment to the data network 180 via the RAN 120. An uplink can include a radio link though which user equipment transmits data and/or control signals to the RAN 120. A downlink can include a radio link through which the RAN 120 transmits data and/or control signals to the user equipment. The UPF node 132 may thus be responsible for functions such as packet routing, packet forwarding, and packet filtering.

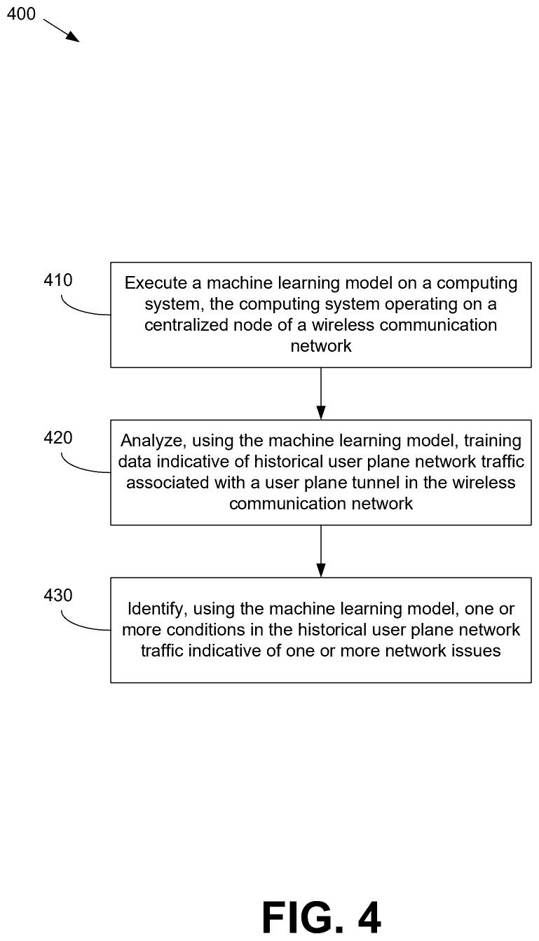

The RAN 120 may be logically divided into a remote radio unit (RRU) 122, the DU 121, and CU 102 (FIG. 1A) that is partitioned into a CU-UP logical node 126 and a CU-CP logical node 124. The CU-UP logical node 126 may correspond with the centralized unit for the user plane and the CU-CP logical node 124 may correspond with the centralized unit for the control plane. The CU-CP logical node 124 may perform functions related to a control plane, such as connection setup, mobility, and security. The CU-UP logical node 126 may perform functions related to a user plane, such as user data transmission and reception functions. Additional details of radio access networks are described in reference to FIGS. 4A-4B.

Decoupling control signaling in the control plane from user plane traffic in the user plane may allow the UPF 132 to be positioned in close proximity to the edge of a network compared with the AMF 134. As a closer geographic or topographic proximity may reduce the electrical distance, this means that the electrical distance from the UPF 132 to the UE 108 may be less than the electrical distance of the AMF 134 to the UE 108. The RAN 120 may be connected to the AMF 134, which may allocate temporary unique identifiers, determine tracking areas, and select appropriate policy control functions (PCFs) for user equipment, via an N2 Interface. The N3 Interface may be used for transferring user data (e.g., user plane traffic) from the RAN 120 to the user plane function UPF 132 and may be used for providing low-latency services using edge computing resources. The electrical distance from the UPF 132 (e.g., located at the edge of a network) to user equipment, such as UE 108, may impact the latency and performance services provided to the user equipment. The UE 108 may be connected to the SMF 133 via an N1 interface not depicted, which may transfer UE information directly to the AMF 134. The UPF 132 may be connected to the data network 180 via an N6 interface. The N6 interface may be used for providing connectivity between the UPF 132 and other external or internal data networks (e.g., to the Internet). The RAN 120 may be connected to the SMF 133, which may manage UE context and network handovers between Base Stations, via the N2 interface. The N2 interface may be used for transferring control plane signaling between the RAN 120 and the AMF 134.

The RRU 122 may perform physical layer functions, such as employing orthogonal frequency-division multiplexing (OFDM) for downlink data transmission. In some cases, the DU 121 may be located at a cell site (or a cellular Base Station) and may provide real-time support for lower layers of the protocol stack, such as the radio link control (RLC) layer and the medium access control (MAC) layer. The CU 102 may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some aspects, a radio access network may correspond with a single CU that connects to multiple DUs 121 (e.g., 10 DUs), and each DU may connect to multiple RRUs (e.g., 18 RRUs). In this case, a single CU may manage 10 different cell sites (or cellular Base Stations) and 180 different RRUs.

In some aspects, the RAN 120 or portions of the RAN 120 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 121 and CU-UP 126 may be executed as virtual instances within a data center environment that provides single-digit millisecond latencies (e.g., less than 2 ms) from the virtual instances to the UE 108.

Aspects described herein may use containerization to implement such microservices. Containerization is the packaging of software code with just the operating system (OS) libraries and dependencies required to run the code to create a single lightweight executable (a container) that runs consistently on any infrastructure. Software platforms, such as Kubernetes, manage containerized workloads and automate the deployment, scaling, and management of containerized applications. Compared to virtual machines (VMs) containers have relaxed isolation properties to share the OS among the applications. Therefore, containers are considered lightweight. A container has its own file system, share of CPU, memory, and process space. As they are decoupled from the underlying infrastructure and are portable across clouds and OS distributions.

A cluster is made up of nodes that run containerized applications. Each cluster also has a master (control plane) that manages the nodes and pods of the cluster. A node represents a single machine in a cluster, typically either a physical machine or virtual machine that is located either on-premises or hosted by a cloud service provider. Each node hosts groups of one or more containers (which run applications), and the master communicates with nodes about when to create or destroy containers and how to re-route traffic based on new container alignments. The Kubernetes master is the access point (or the control plane) from which administrators and other users interact with the cluster to manage the scheduling and deployment of containers.

A pod is the basic unit of scheduling for applications running on a cluster. The applications are running in containers, and each pod includes one or more container(s). While pods are able to house multiple containers, one-container-per-pod may also be used. In some situations, containers that are tightly coupled and need to share resources may sit in the same pod. Pods can quickly and easily communicate with one another as if they were running on the same machine. They do still, however, maintain a degree of isolation. Each pod is assigned a unique IP address within the cluster, allowing the application to use ports without conflict.

When a pod gets created, the pod is scheduled to run on a node. The pod remains on that node until the process is terminated, the pod object is deleted, the pod is evicted for lack of resources, or the node fails. In Kubernetes, pods are the unit of replication. If an application becomes overly popular and a pod can no longer facilitate the load, Kubernetes can deploy replicas of the pod to the cluster.

Software container orchestration platforms, such as Amazon® Elastic Kubernetes Service (Amazon EKS), are services for users to run Kubernetes on the cloud of a cloud computing service provider, such as Amazon® Web Services (AWS®), without the user needing to install, operate, and maintain their own Kubernetes control plane or nodes. An Amazon EKS cluster comprises of two primary components: the Amazon® EKS control plane and Amazon EKS nodes that are registered with the control plane. The Amazon® EKS control plane comprises of control plane nodes that run the Kubernetes software and the Kubernetes application programming interface (API) server. The control plane may run in an account managed by AWS® or the telecommunication service provider, and the Kubernetes API is exposed via the Amazon® EKS endpoint associated with the cluster. Each Amazon® EKS cluster control plane is single-tenant and unique, and runs on its own set of Amazon® Elastic Compute Cloud (EC2) instances, which provide scalable computing capacity in the AWS® cloud.

However, other types of cloud compute instances or virtual machine instances may be used on various other cloud computing provider service platforms. The cluster control plane may be provisioned across multiple Availability Zones (aZs) and fronted by an Elastic Load Balancing Network Load Balancer. Amazon® EKS may also provision clastic network interfaces in VPC subnets to provide connectivity from the control plane instances to the nodes. Amazon® EKS nodes may run in an AWS account of the telecommunication service provider and connects to the telecommunication service provider's cluster control plane via the API server endpoint and a certificate file that is created for the cluster.

As disclosed herein, network functions (NFs) of the 5G NR cellular telecommunication network implemented in respective node groups are useful mechanisms for creating pools of resources in the 5G network that can enforce scheduling requirements. These NFs also provide a utility for shifting workloads around in the 5G network during cluster management and updates. Such NFs of the 5G NR cellular telecommunication network may be hosted on a cloud service provider cloud and referred to herein as cloud-native network functions (CNFs).

In some aspects, the CU-UP logical node 126 and/or the CU-CP logical node 124 are executed as pods, e.g., one or more of a CU-UP pod and a CU-CP pod running on a first cloud compute instance within a node group of a cluster being hosted on a first cloud compute instance. In other aspects, the CU-UP logical node 126 and/or the CU-CP logical node 124 are containers, nodes, logical units, or circuits configured to execute firmware and/or software to implement functionality of CU-UP and CU-CP logical nodes, respectively.

The wireless communication network 100 may include a machine learning component 170. In some aspects, the machine learning component 170 may be executed on a computing device associated with the core network 130. For example, the machine learning component 170 may be implemented on the UPF 132 of the core network 130. In some other aspects, the machine learning component 170 (or a portion of the machine learning component) may be executed on the RAN 120, such as on the DU 121, CU-UP 126, CU-UP 124, or RRU 122.

The machine learning component 170 may include an analysis component 172 and a monitoring component 174. The analysis component 172 may analyze historical user plane network traffic associated with a user plane tunnel in the wireless communication network 100 and may determine one or more conditions in the first user plane network traffic indicative of one or more network issues. The monitoring component 174 may monitor real-time user plane network traffic associated with the user plane tunnel and may detect an occurrence of the one or more conditions in the second user plane network traffic. In some aspects, the analyzing component 172 may determine one or more network parameters to be adjusted (based on detecting the occurrence of the one or more conditions in the second user plane network traffic) and may send an indication of the one or more network parameters to be adjusted to one or more other components or functions of the core network 130. In some other aspects, one or more other components or functions of the core network 130 may determine the one or more network parameters to be adjusted based on the machine learning component 170 detecting the occurrence of the one or more conditions in the user plane network traffic.

FIG. 1C depicts a RAN 120 and a core network 130 for providing a communications channel (or channel) between user equipment and data network 180 according to at least one embodiment. The core network 130 includes the UPF 132 for handling user data in the core network 130. Data is transported between the RAN 120 and the core network 130 via the N3 Interface. The data may be tunneled across the N3 Interface (e.g., IP routing may be done on the tunnel header IP address instead of using end user IP addresses). This may allow for maintaining a stable IP anchor point even though the UE 108 may be moving around a network of cells or moving from one coverage area into another coverage area. The UPF 132 may connect to external data networks, such as the data network 180 via the N6 interface. The data may not be tunneled across the N6 interface as IP packets may be routed based on end user IP addresses. The UPF 132 may connect to the SMF 133 via the N4 interface.

In some aspects, the N3 interface is configured to transfer user plane data (i.e., the actual data traffic like voice, video, internet data, etc.) between the gNB (e.g., the CU-UP logical node 126 of the RAN 120) and the UPF 132. The CU-UP logical node 126 may employ the GPRS Tunneling Protocol for the User plane (GTP-U) over the N3 interface for data packet encapsulation and tunneling. The N3 interface can support the segmentation and reassembly of user plane PDUs. The N3 interface provides mechanisms for path management, which includes establishing, modifying, and releasing GTP-U tunnels, e.g., by the CU-UP logical node 126. The 5G architecture allows for flexible deployment options, and thus the physical distance between gNB and UPF can vary based on the deployment. For example, in edge computing scenarios, the UPF 132 might be located closer to the RAN 120 (and hence the gNB) to reduce latency. Conversely, in other scenarios, the UPF 132 might be more centralized, leading to a longer N3 interface in terms of physical distance.

As depicted, the core network 130 includes a group of control plane functions 140 including SMF 133, AMF 134, PCF 135, NRF 136, AF 137, and NSSF 138. The SMF 133 may configure or control the UPF 132 via the N4 interface. For example, the SMF 133 may control packet forwarding rules used by the UPF 132 and adjust QoS parameters for QoS enforcement of data flows (e.g., limiting available data rates). In some cases, multiple SMF/UPF pairs may be used to simultaneously manage user plane traffic for a particular user device, such as UE 108. For example, a set of SMFs may be associated with UE 108, where each SMF of the set of SMFs corresponds with a network slice. The SMF 133 may control the UPF 132 on a per end user data session basis, in which the SMF 133 may create, update, and remove session information in the UPF 132.

In some cases, the SMF 133 may select an appropriate UPF for a user plane path by querying the NRF 136 to identify a list of available UPFs and their corresponding capabilities and locations. The SMF 133 may select the UPF 132 based on a physical location of the UE 108 and a physical location of the UPF 132 (e.g., corresponding with a physical location of a data center in which the UPF 132 is running). The SMF 133 may also select the UPF 132 based on a particular network slice supported by the UPF 132 or based on a particular data network that is connected to the UPF 132. The ability to query the NRF 136 for UPF information eliminates the need for the SMF 133 to store and update the UPF information for every available UPF within the core network 130.

In some aspects, the SMF 133 may query the NRF 136 to identify a set of available UPFs 132 for a packet data unit (PDU) session and acquire UPF information from a variety of sources, such as the AMF 134 or the UE 108. The UPF information may include a location of the UPF 132, a location of the UE 108, the UPF's dynamic load, the UPF's static capacity among UPFs supporting the same data network, and the capability of the UPF 132.

The RAN 120 may provide separation of the centralized unit for the CU-CP logical node 124 and the CU-UP 126 functionalities while supporting network slicing. The CU-CP logical node 124 may obtain resource utilization and latency information from the DU 121 and/or the CU-UP logical node 126 and select a CU-UP logical node 126 to pair with the DU 121 based on the resource utilization and latency information in order to configure a network slice. Network slice configuration information associated with the network slice may be provided to the UE 108 for purposes of initiating communication with the UPF 132 using the network slice.

FIG. 2 is a block diagram of an example architecture of customizable pipeline (CP) 200 that supports training, configuring, and deploying of one or more machine learning models, in accordance with at least some embodiments. As depicted in FIG. 2, a CP 200 may be implemented on a computing device 202, but it should be understood that any engines and components of computing device 202 may be implemented on (or shared among) any number of computing devices or on a cloud. Computing device 202 may be a desktop computer, a laptop computer, a smartphone, a tablet computer, a server, a computing device that accesses a remote server, a computing device that utilizes a virtualized computing environment, a gaming console, a wearable computer, a smart TV, and so on. A user of CP 200 may have a local or remote (e.g., over a network) access to computing device 202. Computing device 202 may have (not shown in FIG. 2) any number of central processing units (CPUs) and graphical processing units (GPUs), including virtual CPUs and/or virtual GPUs, or any other suitable processing devices capable of performing the techniques described herein. Computing device 202 may further have (not shown in FIG. 2) any number of memory devices, network controllers, peripheral devices, and the like. Peripheral devices may include cameras (e.g., video cameras) for capturing images (or sequences of images), microphones for capturing sounds, scanners, sensors, or any other devices for data intake.

In some embodiments, a CP 200 may include a number of engines and components for efficient MLM implementation. A user (customer, end user, developer, data scientist, etc.) may interact with CP 200 via a user interface UI 204, which may include a command line, a graphical UI, a web-based interface (e.g., a web-browser accessible interface), a mobile application-based UI, or any combination thereof. UI 204 may display menus, tables, graphs, flowcharts, graphical and/or textual representations of software, data, and workflows. UI 204 may include selectable items, which may enable the user to enter various pipeline settings, provide training/retraining and other data, as described in more detail below. User actions entered via UI 204 may be communicated to a pipeline orchestrator 210 of CP 200 via a pipeline API 206. In some embodiments, prior to receiving pipeline data from pipeline orchestrator 210, the user (or the remote computing device that the user is using to access the pipeline) may download an API package to the remote computing device. The downloaded API package may be used to install pipeline API 206 on the remote computing device to enable the user to have a two-way communication with pipeline orchestrator 210 during setting up and using CP 200.

Pipeline orchestrator 210, via pipeline API 206, may provide the user with various data that may be used in configuring and deploying one or more MLMs and using the deployed MLMs for processing (inferencing) of various input user data. For example, pipeline orchestrator 210 may provide the user with information about available pre-trained MLMs, may enable retraining of pre-trained MLMs on user-specific data provided by the user or training of new (previously untrained) MLMs. Pipeline orchestrator 210 may then build CP 200 based on the information received from the user. For example, pipeline orchestrator 210 may configure user-selected MLMs and deploy the selected MLMs together with various other (e.g., pre- and post-processing) stages that are used in implementing the selected MLMs. To perform these and other tasks, pipeline orchestrator 210 may coordinate and manage a number of engines, each engine implementing a part of the overall pipeline functionality.

In some embodiments, CP 200 may have access to one or more previously trained (pre-trained) MLMs and may, therefore, provide the user with access to at least some (e.g., based on the user's subscription) of these pre-trained MLMs. The MLMs may be trained for common tasks in the area of the CP specialization. For example, a CP that is specialized in speech processing may have access to one or more MLMs trained to recognize some typical speech, such as customer service requests, common conversations, and the like. CP 200 may further include a training engine 220. Training engine 220 may implement retraining (additional training) of the pre-trained MLMs. Retraining may be performed using retraining data tailored for a user-specific domain of use. In some embodiments, the retraining data may be provided by the user. For example, a user may provide retraining data to enhance natural language processing capabilities of one of the pre-trained MLMs to improve recognition of speech that may be encountered in an investment brokerage environment or a securities trading environment. The data may be provided (e.g., by a technology specialist at the user's financial company) in the form of audio digital recordings in any available (compressed or uncompressed) digital format, e.g., WAV, WavPack, WMA, MP3, MPEG-4, as a sound track of a video recording, a TV program, and the like.

Pre-trained MLMs 222 may be stored in a trained model repository 224, which may be accessible to computing device 202 over a network 240. Pre-trained MLMs 222 may be trained by a training server 262. Network 240 may be a public network (e.g., the Internet), a private network (e.g., a local area network (LAN), or wide area network (WAN)), a wireless network, a personal area network (PAN), or a combination thereof. In some embodiments, training server 262 may be a part of computing device 202. In other embodiments, training server 262 may be communicatively coupled to computing device 202 directly or via network 240. Training server 262 may be (and/or include) a rackmount server, a router computer, a personal computer, a laptop computer, a tablet computer, a desktop computer, a media center, or any combination thereof. Training server 262 may include a training engine 260. The training engine 260 on training server 262 may be the same as (or similar to) training server 262 on computing device 202. In some embodiments, training engine 220 on computing device 202 may be absent; instead, all training and retraining may be performed by training engine 260 on training server 262. In some embodiments, training engine 260 may perform off-site training of pre-trained MLMs 222 whereas training engine 220 on computing device 202 may perform retraining of pre-trained MLMs 222 as well as training of new (custom) MLMs 225.

During training or retraining, training engine 260 (220) may generate and configure one or more MLMs. MLMs may include regression algorithms, decision trees, support vector machines, K-means clustering models, neural networks, or any other machine learning algorithms. Neural network MLMs may include convolutional, recurrent, fully connected, Long Short Term Memory models, Hopfield, Boltzmann, or any other types of neural networks. Generating MLMs may include setting up an MLM type (e.g., a neural network), architecture, a number of layers of neurons, types of connections between the layers (e.g., fully connected, convolutional, deconvolutional, etc.), the number of nodes within each layer, types of activation functions used in various layers/nodes of the network, types of loss functions used in training of the network, and so on. Generating MLMs may include setting (e.g., randomly) initial parameters (weights, biases) of various nodes of the networks. The generated MLMs may be trained by training engine 260 using training data that may include training input(s) 265 and corresponding target output(s) 267.

For example, for training of speech recognition MLMs 222, training inputs 265 may include one or more digital sound recordings with utterances of words, phrases, and/or sentences that the MLM is being trained to recognize. Target outputs 267 may include indications of whether the target words and phrases are present in the training inputs 265. Target outputs 267 may also include transcriptions of the utterances, and so on. In some embodiments, target outputs 267 may include identification of a speaker's intent. For example, a customer calling a food delivery service may express a limited number of intentions (to order food, to check on the status of the order, to cancel the order, etc.) but may do so in a practically unlimited number of ways. Whereas specific words and sentences uttered may not be of much significance, determination of the intent may be important. Accordingly, in such embodiments, target outputs 267 may include a correct category of intent. Similarly, a target output 267 for a training input 265 that includes an utterance of a client calling a customer service phone may be both a transcription of the utterance as well as an indication of an emotional state of the client (e.g., angry, worried, satisfied, etc.). Additionally, training engine 260 may generate mapping data 266 (e.g., metadata) that associates training input(s) 265 with correct target output(s) 267. During training of MLMs 222 (or custom MLMs 225), training engine 260 (or 220) may identify patterns in training input(s) 265 based on desired target output(s) 267 and train the respective MLMs to perform desired tasks. Predictive utility of the identified patterns may subsequently be verified using additional training input/target output associations before being used, during inference stage, in future processing of new speeches. For example, upon receiving a new voice message, a trained MLM 222 may be able to identify that the customer wishes to check on the status of a previously placed order, identify the name of the customer, the order number, and so on.

In some embodiments, multiple MLMs may be trained, simultaneously or separately. A speech identification pipeline may involve multiple models, e.g., an acoustic model for sound processing, such as parsing speech into words, a language model for recognition of parsed words, a model for intent identification, a model for understanding a question, or any other models. In some embodiments, some of the models may be trained independently while other models may be trained concurrently. For example, the acoustic model may be trained separately from all other models of language processing, intent identification model may be trained together with a speech transcription model, and so on.

In some embodiments, each or some of MLMs 222 (and/or MLMs 225) may be implemented as deep learning neural networks having multiple levels of linear or non-linear operations. For example, each or some of speech recognition MLMs may be convolutional neural networks, recurrent neural networks (RNN), fully connected neural networks, and so on. In some embodiments, each or some of MLMs 222 (and/or MLMs 225) may include multiple neurons wherein each neuron may receive its input from other neurons or from an external source and may produce an output by applying an activation function to the sum of (trainable) weighted inputs and a bias value. In some embodiments, each or some of MLMs 222 (and/or 225) may include multiple neurons arranged in layers, including an input layer, one or more hidden layers, and an output layer. Neurons from adjacent layers may be connected by weighted edges. Initially, edge weights may be assigned some starting (e.g., random) values. For every training input 265, training engine 260 may cause each or some of MLMs 222 (and/or MLMs 225) to generate output(s). Training engine 237 may then compare observed output(s) with the desired target output(s) 267. The resulting error or mismatch, e.g., the difference between the desired target output(s) 267 and the actual output(s) of the neural networks, may be back-propagated through the respective neural networks, and the weights in the neural networks may be adjusted to make the actual outputs closer to the target outputs 267. This adjustment may be repeated until the output error for a given training input 265 satisfies a predetermined condition (e.g., falls below a predetermined value). Subsequently, a different training input 265 may be selected, a new output generated, and a new series of adjustments implemented, until the respective neural networks are trained to an acceptable degree of accuracy.

Training engine 220 may include additional (compared with training engine 260) components to implement retraining of previously trained MLMs 222 for domain-specific applications. For example, training engine 220 may include a data augmentation module, to augment existing training data (e.g., training inputs 265) with domain-specific data. For example, existing sound recordings may be augmented with target words and phrases that are commonly encountered in the target domain. For example, the data augmentation module may augment existing training inputs with utterances of phrases “short sale,” “capital gain tax,” “hedge fund,” “economic fundamentals,” “initial public offering,” and so on. Target outputs 267 may similarly be augmented. For example, the data augmentation module may update target outputs 267 with various terms of art, such as “options,” “futures,” that have domain-specific meaning. Training engine 220 may additionally have a pruning module to reduce the number of nodes and an evaluation module to determine whether the pruning of nodes has not reduced the accuracy of the retrained model below a minimum threshold accuracy.

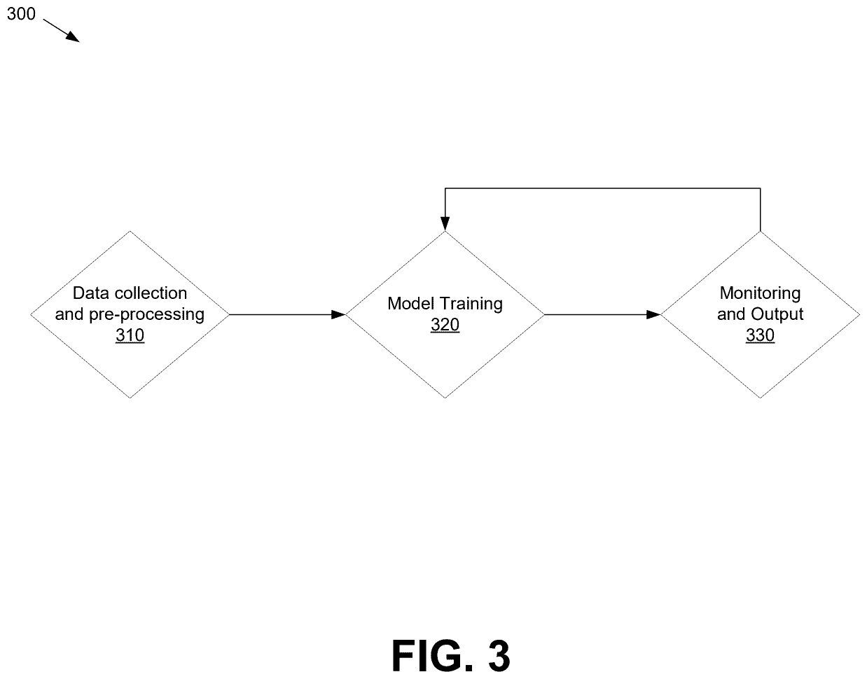

In some aspects, one or more components of the CP 200 may be used for training a machine learning model. For example, one or more components of the CP 200, such as the training engine 220 and the training server 262 (among other examples), may be used for training the machine learning component 170 operating on a computing device of the core network 130. Additional details regarding training the machine learning model are described, for example, at operation 310 and operation 320 of FIG. 3.

FIG. 3 is a sequence diagram 300 of a machine learning component monitoring network traffic and a core network function adjusting network parameters according to various aspects of the present disclosure. As described herein, the machine learning component 170 may be executed on the core network 130, or may otherwise communicate with the core network 130, to monitor and analyze network traffic. For example, the machine learning component 170 may be executed by a computing device hosted by a centralized node associated with the core network 130. The core network node 130 (for example, the UPF 132) may adjust one or more network parameters (for example, one or more core network parameters) based on an output of the machine learning component 170.

The machine learning component 170 may predict potential network issues and may adjust timers and thresholds proactively. In some aspects, the machine learning component 170 may analyze historical GTP-U network data, traffic patterns, packet loss rates, latency trends, and/or performance metrics, among other examples. By training the machine learning model 170 on this data, the machine learning model 170 can learn to recognize patterns indicative of potential network issues.

In some aspects, the machine learning model 170 can detect anomalies or deviations from normal behavior in real-time GTP-U traffic. For example, sudden spikes in packet loss or unexpected latency increases could signal underlying network problems. In some aspects, the machine learning model 170 may identify a pattern where a specific GTP-U tunnel consistently experiences high traffic during peak hours, leading to congestion and degraded performance. Based on this prediction, the core network 130 (and/or the machine learning model 170) can proactively adjust timers and thresholds related to that tunnel to mitigate congestion before it impacts users. The machine learning model can guide the dynamic adjustment of timers and thresholds within the GTP-U protocol stack. This includes parameters such as retransmission timers, timeout timers, congestion thresholds, maximum number of retransmissions, and retransmission timeouts, among other examples. If the machine learning model 170 predicts an increased likelihood of packet loss on a particular path due to network conditions, the core network 130 can automatically adjust retransmission timers for (such as a retransmission timer for GTP-U echo requests) to account for potential delays. By doing so, the network can proactively handle potential packet loss scenarios without waiting for actual failures to occur.

In some aspects, the machine learning model 170 can be used to optimize network resource allocation based on predicted traffic patterns and user demand. For example, during anticipated periods of high usage, the core network 130 (and/or the machine learning model 170) can allocate additional resources to particular GTP-U tunnels preemptively. If the machine learning model 170 predicts a surge in demand for specific GTP-U paths or services, load balancing algorithms at the core network 130 can be triggered to distribute traffic evenly across multiple UPFs or network segments. This proactive approach ensures scalability and reduces performance degradation before they impact user experience. In some aspects, the machine learning model 170 can continuously learn from real-time network data to refine predictions and optimize strategies over time. This adaptive learning process enables the wireless communication network to stay responsive to evolving conditions and challenges.

At operation 310, the core network 130 (and/or the machine learning component 170) may perform data collection and pre-processing. The core network 130 may gather relevant data from the GTP-U network, including traffic data, performance metrics, error logs, and historical patterns, among other examples. This data may be preprocessed to clean, normalize, and/or prepare the data for analysis by the machine learning model 170. The core network 130 and/or the machine learning model 170 may perform feature identification to identify and extract, from the pre-processed data, features that are indicative of network behavior and performance. These features may include packet loss rates, latency measurements, traffic volume, and session durations, among other examples. Once the machine learning model 170 is trained and validated, the machine learning model 170 may be deployed in the GTP-U network environment and may continuously monitor incoming network data (in real time). When the machine learning model 170 identifies patterns or deviations that match predefined criteria (such as high traffic congestion or unusual packet loss rates), the machine learning model 170 can generate predictions or flag anomalies for further investigation. Based on the predictions or anomaly detections made by the machine learning model 170, automated decision-making processes can be triggered within a network management system (e.g., a network management system included in the core network 130). These decisions can include adjusting timers and thresholds, reallocating resources, triggering failover mechanisms, or sending alerts to network operators for manual intervention, among other examples.

The machine learning model 170 may be evaluated (continuously) against actual network outcomes. Feedback data, including the effectiveness of model-driven actions and any discrepancies between predicted and observed behavior, can be used to improve the machine learning model 170 over time. Through continuous monitoring, learning, and adaptation, the machine learning model 170 can become more accurate and effective in predicting and avoiding GTP-U issues, for example, by adapting to changes in network conditions, user behavior, and ensuring proactive and responsive network management.

At operation 320, the machine learning component 170 may be trained. The machine learning model 170 may be trained to enable the machine learning model to predict potential network issues and to adjust timers and thresholds in the GTP-U. As described herein, the core network 130 may collect data from the GTP-U network. This data may include historical network performance metrics, traffic patterns, error logs, configuration parameters, or operational data, among other examples. The collected data may be pre-processed to prepare the data for analysis by the machine learning model 170. Pre-processing the data may include, for example, data cleaning, handling missing values, data normalization, and feature extraction, among other examples. Features that are indicative of GTP-U behavior, performance issues, and potential anomalies may be identified and extracted from the pre-processed data. These features may include packet loss rates, latency measurements, traffic volume, QoS parameters, and historical patterns, among other examples.

In supervised learning scenarios, the data may be labeled to define the output that the model is to predict. The labeled data can be split into training set(s) and validation set(s). A training set can be used to train the machine learning model 170, while a validation set can be used to evaluate the performance of the machine learning model 170. The training process may include ingesting the labeled training data into the selected machine learning model 170. The machine learning model 170 can learn from the input features and their corresponding labels to make predictions about the network. Additionally, a performance of the trained machine learning model performance can be evaluated using the validation set.

At operation 330, the machine learning component 170 may can monitor network traffic and can generate an output based on monitoring the network traffic. Once the training of the machine learning model 170 using the validation set is complete, the machine learning model 170 can be deployed for real-time predictions and monitoring in the GTP-U network environment. The deployed machine learning model 170 can be continuously monitored, and predictions by the machine leaning model 170 can be compared against actual network outcomes. Feedback data from network and performance metrics can be used for ongoing model maintenance, retraining, and refinement to ensure its effectiveness in predicting and handling network issues.

The output of the machine learning model can be used for predicting potential network issues and adjusting timers and thresholds in the GTP-U and may be integrated into the network management. The output of the machine learning model 170, which may include predictions about potential network issues or anomalies, can trigger automated alerts and notifications. These alerts can be sent to network teams to inform them about problems or abnormal behavior in the network. Additionally, or alternatively, the output of the machine learning model 170 can be visualized on dashboards and monitoring systems. Predictions, trends, and recommended actions that are based on the machine learning model analysis can be displayed on a user interface.

The output of the machine learning model 170 can directly influence automated actions within the network. For example, if the machine learning model 170 predicts congestion on a particular path, the machine learning model 170 may trigger automatic adjustments to timers, thresholds, or routing configurations to avoid the issue proactively. By analyzing the output of the machine learning model 170, network performance and resource utilization can be optimized. For example, the machine learning model recommendations may enhance load balancing strategies or traffic rerouting to improve overall network efficiency.

The output of the machine learning model 170 can be used to assist in incident management and troubleshooting efforts. The predictions and insights by the machine learning model 170 can be used to prioritize tasks, allocate resources effectively, and address potential issues before they escalate into major issues. Additionally, network policies and configurations can be adapted (dynamically) based on the output of the machine learning model 170. For example, the machine learning model 170 may generate an output that indicates to adjust QoS parameters or apply traffic policies to better handle predicted traffic patterns. The output of the machine learning model 170 can be integrated into network management, automation, performance optimization, and decision-making processes to enhance the reliability, efficiency, and responsiveness of the GTP-U network.

In some aspects, the machine learning model 170 can output average values based on GTP-U historical data and real-time observations. These values may include mean values and/or standard deviation values indicative of packet loss rates, latency, throughput, traffic volume, peak usage periods, and frequencies of performance degradation events, among other examples.

In some aspects, based on the values and machine learning analysis, the machine learning model 170 can provide recommendations for updating parameters (such as parameters related to GTP-U). For example, the machine learning model can provide recommendations for adjusting retransmission timers for Echo Requests based on predicted packet loss rates or latency trends, dynamically modifying congestion control thresholds to optimize network performance during peak usage periods, and/or tuning QoS settings based on real-time traffic patterns and user demand. In some aspects, the output of the machine learning model 170 can guide resource allocation decisions for the UPF in real-time and on an ongoing basis. For example, the machine learning model can scale UPF resources (such as CPU, memory, or network interfaces) up or down based on demand fluctuations and performance requirements, and/or may optimize resource utilization to minimize latency, packet loss, and service disruptions.

The output of the machine learning model 170 can feed into a real-time monitoring and adjustment system that continuously evaluates network conditions and updates parameters accordingly. This monitoring and adjustment system can improve a likelihood of immediate response to detected anomalies or predicted network issues to prevent service degradation, adaptive resource allocation to maintain optimal UPF performance and user experience in dynamic network environments, and continuous optimization based on feedback loops, performance metrics, and ML-driven insights, among other examples.

As described herein, integrating statistical values, real-time updates, and ML-driven recommendations into GTP-U network management can enable dynamic resource allocation, parameter adjustments, and proactive response to network challenges. This can improve UPF resource utilization, enhance network efficiency, and maintain high-quality service delivery for users.

FIG. 4 is a flow chart of an example method 400 of training a machine learning model for adjusting network parameters according to various aspects of the present disclosure. In some aspects, the method 400 may be performed by a machine learning model that operates on centralized network node. For example, the method 400 may be performed by the machine learning component 170 that is executed on a computing device of the core network 130. The method includes executing the machine learning model on the computing system, where the computing system operates on a centralized node of a wireless communication network (block 410). The centralized node of the wireless communication network may be the core network 130 (or one or more components of the core network 130, such as the UPF 132). The method further includes analyzing, using the machine learning model, training data indicative of historical user plane network traffic associated with the user plane tunnel in the wireless communication network (block 420). The method further includes identifying, using the machine learning model, one or more conditions in the historical user plane network traffic (block 430). The one or more conditions may be one or more conditions in the historical user plane network traffic indicative of one or more network issues.

In some aspects, the user plane network traffic is general packet radio service (GPRS) tunneling protocol (GTP) user plane function (GTP-U) network traffic.

In some aspects, analyzing the training data comprises analyzing at least one of a traffic volume, a packet loss rate, a latency, or a quality of service associated with the historical user plane network traffic.

In some aspects, a computing system for adjusting network parameters in a wireless communication network may include one or more processing devices and memory communicatively coupled with and readable by the one or more processing devices and having stored therein processor-readable instructions which, when executed by the one or more processing devices, cause the one or more processing devices to perform one or more operations of the method 400.

In some aspects, one or more non-transitory, computer-readable storage media may have computer-readable instructions thereon which, when executed by one or more processing devices, cause the one or more processing devices to perform one or more operations of the method 400.

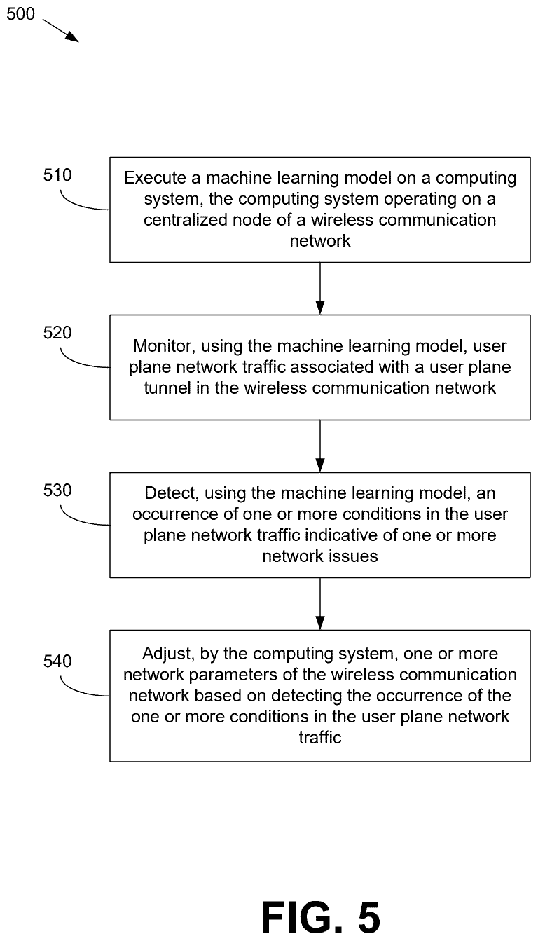

FIG. 5 is a flow chart of an example method 500 of adjusting network parameters using machine learning according to various aspects of the present disclosure. In some aspects, the method 500 may be performed by a machine learning model that operates on centralized network node. For example, the method 500 may be performed by the machine learning component 170 that is executed on a computing device of the core network 130. executing the machine learning model on the computing system, where the computing system operates on a centralized node of a wireless communication network (block 510). The centralized node of the wireless communication network may be the core network 130 (or one or more components of the core network 130, such as the UPF 132). The method further includes monitoring, using the machine learning model, user plane network traffic associated with a user plane tunnel in the wireless communication network (block 520). The method further includes detecting, using the machine learning model, an occurrence of one or more conditions in the user plane network traffic indicative of one or more network issues (block 530). The method further includes adjusting, by the computing system, one or more network parameters of the wireless communication network based on detecting the occurrence of the one or more conditions in the user plane network traffic (block 540).

In some aspects, the user plane network traffic is real-time general packet radio service (GPRS) tunneling protocol (GTP) user plane function (GTP-U) network traffic.

In some aspects, detecting the occurrence of the one or more conditions in the user plane network traffic comprises detecting at least one of an increase in traffic volume, an increase in a packet loss rate, an increase in latency, or a decrease in a quality of service in the user plane network traffic.

In some aspects, adjusting the one or more network parameters comprises at least one of adjusting a timer associated with the user plane tunnel, adjusting a threshold associated with the user plane tunnel, allocating one or more resources to the user plane tunnel, performing a load balancing for the user plane network traffic, or re-routing the user plane network traffic to another user plane tunnel. In some aspects, adjusting the timer associated with the user plane tunnel comprises adjusting at least one of a re-transmission timer, a timeout timer, or a re-transmission timeout timer associated with the user plane tunnel, and wherein adjusting the threshold associated with the user plane tunnel comprises adjusting at least one of a congestion threshold or a maximum quantity of permitted re-transmissions associated with the user plane tunnel.

In some aspects, adjusting the one or more network parameters comprises adjusting at least one of a network policy, a network configuration, or a quality of service requirement associated with the user plane tunnel.

In some aspects, the method further includes generating, using the machine learning model, an output value that indicates at least one of a packet loss rate, a latency, a throughput, an average traffic volume, a peak usage time period, or a frequency of performance degradation events associated with the user plane network traffic, wherein the output value is an average value or a standard deviation value.

In some aspects, a computing system for adjusting network parameters in a wireless communication network may include one or more processing devices and memory communicatively coupled with and readable by the one or more processing devices and having stored therein processor-readable instructions which, when executed by the one or more processing devices, cause the one or more processing devices to perform one or more operations of the method 500.

In some aspects, one or more non-transitory, computer-readable storage media may have computer-readable instructions thereon which, when executed by one or more processing devices, cause the one or more processing devices to perform one or more operations of the method 500.

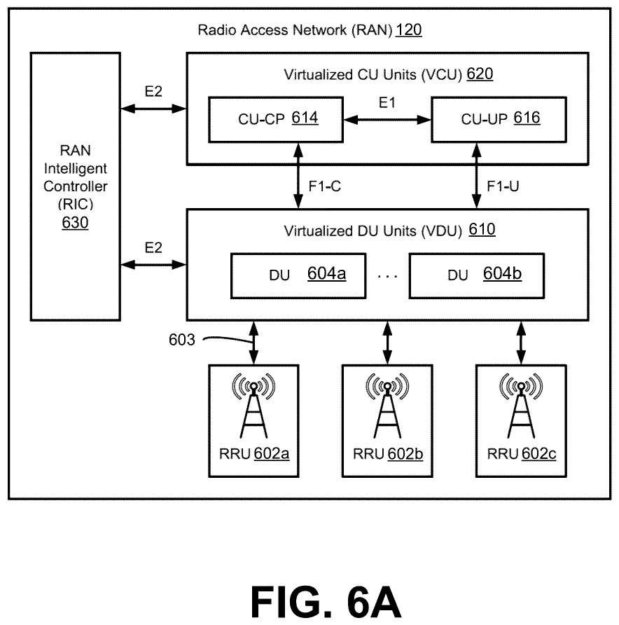

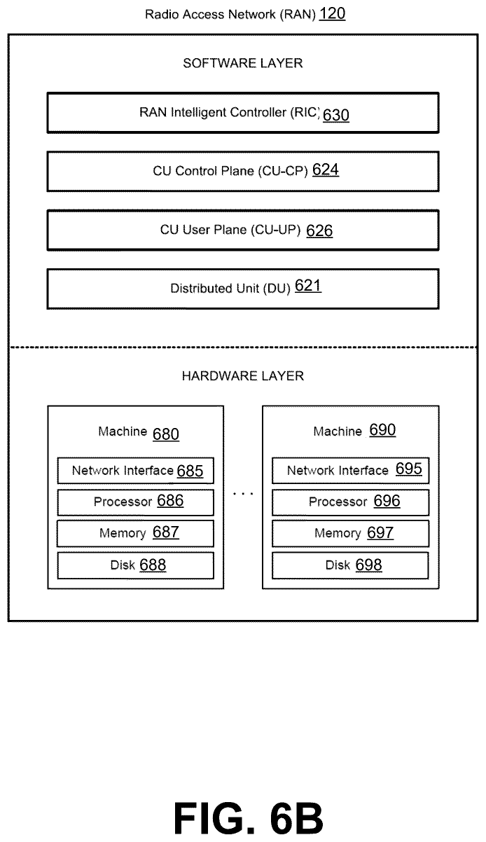

FIG. 6A depicts a RAN 120 according to at least one embodiment. The RAN 120 includes virtualized CU units (VCU) 620, virtualized DU units (VDU) 610, remote radio units (RRUs) 602a-602c, and a RAN intelligent controller (RIC) 630. The virtualized DU units 610 can include virtualized versions of distributed units (DUs) 604. The distributed unit (DU) 604 can include a logical node configured to provide functions for the radio link control (RLC) layer, the medium access control (MAC) layer, and the physical layer (PHY) layers. The virtualized CU units 620 can include virtualized versions of centralized units (CUs) including a centralized unit for a user plane CU-UP 626 and a centralized unit for a control plane CU-CP 614. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane CU-CP 614 can include a logical node configured to provide functions of the control plane part of the RRC and PDCP. The centralized unit for the user plane CU-UP 616 can include a logical node configured to provide functions of the user plane part of the SDAP and PDCP. Virtualizing the control plane and user plane functions allows the centralized units (CUs) to be consolidated in one or more data centers on RAN-based open interfaces.

The remote radio units (RRUs) 602a-602c may correspond with different cell sites. A single DU may connect to multiple RRUs via a fronthaul interface 603. The fronthaul interface 603 may provide connectivity between DUs and RRUs. For example, DU 604a may connect to 18 RRUs via the fronthaul interface 603. Centralized units (CUs) may control the operation of multiple DUs via a mid-haul F1 Interface that includes the F1-C and F1-U interfaces. The F1 Interface may support control plane and user plane separation and separate the Radio Network Layer and the Transport Network Layer. In one example, the centralized unit for the control plane CU-CP 614 may connect to ten different DUs within the virtualized DU units 610. In this case, the centralized unit for the control plane CU-CP 614 may control ten DUs and 180 RRUs. A single Distributed Unit (DU) 604 may be located at a cell site or in a local data center. Centralizing the Distributed Unit (DU) 604 at a local data center or at a single cell site location instead of distributing the DU 604 across multiple cell sites may result in reduced implementation costs.

The centralized unit for the control plane CU-CP 614 may host the radio resource control (RRC) layer and the control plane part of the packet data convergence control (PDCP) layer. The E1 Interface may separate the Radio Network Layer and the Transport Network Layer. The CU-CP 614 terminates the E1 Interface connected with the centralized unit for the user plane CU-UP 616 and the F1-C interface connected with the distributed units (DUs) 604. The centralized unit for the user plane CU-UP 616 hosts the user plane part of the packet data convergence control (PDCP) layer and the service data adaptation protocol (SDAP) layer. The CU-UP 616 terminates the E1 Interface connected with the centralized unit for the control plane CU-CP 614 and the F1-U interface connected with the distributed units (DUs) DU 604. The distributed units (DUs) 604 may handle the lower layers of the baseband processing up through the packet data convergence control (PDCP) layer of the protocol stack. The interfaces F1-C and E1 may carry signaling information for setting up, modifying, relocating, and/or releasing a UE context.

The RAN intelligent controller (RIC) 630 may control the underlying RAN elements via the E2 Interface. The E2 Interface connects the RAN intelligent controller (RIC) 630 to the distributed units (DUs) 604 and the centralized units CU-CP 614 and CU-UP 616. The RAN intelligent controller (RIC) 630 can include a near-real time RIC. A non-real-time RIC (NRT-RIC) not depicted can include a logical node allowing non-real time control rather than near-real-time control and the near-real-time RIC 630 can include a logical node allowing near-real-time control and optimization of RAN elements and resources on the bases of information collected from the distributed units (DUs) 604 and the centralized units CU-CP 614 and CU-UP logical node 616 via the E2 Interface.

The virtualization of the distributed units (DUs) 604 and the centralized units CU-CP 614 and CU-UP 616 allows various deployment options that may be adjusted over time based on network conditions and network slice requirements. In at least one example, both a Distributed Unit (DU) 604 and a corresponding centralized unit CU-UP 616 may be implemented at a cell site. In another example, a Distributed Unit (DU) 604 may be implemented at a cell site and the corresponding centralized unit CU-UP 616 may be implemented at a local data center (LDC). In another example, both a Distributed Unit (DU) 604 and a corresponding centralized unit CU-UP 616 may be implemented at a local data center (LDC). In another example, both a Distributed Unit (DU) 604 and a corresponding centralized unit CU-UP 616 may be implemented at a cell site, but the corresponding the centralized unit CU-CP logical node 614 may be implemented at a local data center (LDC). In another example, a Distributed Unit (DU) 604 may be implemented at a local data center (LDC) and the corresponding centralized units CU-CP 614 and CU-UP 616 may be implemented at an edge data center (EDC).

In some aspects, network slicing operations may be communicated via the E1, F1-C, and F1-U interfaces of the RAN 120. For example, CU-CP 614 may select the appropriate DU 604 and CU-UP 616 entities to serve a network slicing request associated with a particular service level agreement (SLA).

FIG. 6B depicts a RAN 120 according to at least one embodiment. As depicted, the RAN 120 includes hardware-level components and software-level components. The hardware-level components include a set of machines (e.g., physical machines) that may be grouped together and presented as a single computing system or a cluster. Each machine of the set of machines can include a node in a cluster (e.g., a failover cluster).

As depicted, the set of machines include machine 680 and machine 690. The machine 680 includes a network interface 685, processor 686, memory 687, and disk 688 all in communication with each other. Processor 686 allows machine 680 to execute computer readable instructions stored in memory 687 to perform processes described herein. Processor 686 may include one or more processing units, such as one or more CPUs and/or one or more GPUs. Memory 687 can include one or more types of memory (e.g., RAM, SRAM, DRAM, ROM, EEPROM, or Flash). The disk 688 can include a hard disk drive and/or a solid-state drive. Similarly, the machine 690 includes a network interface 695, processor 696, memory 697, and disk 698 all in communication with each other. Processor 696 allows machine 690 to execute computer readable instructions stored in memory 697 to perform processes described herein. In some aspects, the set of machines may be used to implement a failover cluster. In some cases, the set of machines may be used to run one or more virtual machines or to execute or generate a containerized environment, such as a containerized environment.

The software-level components include a RAN intelligent controller (RIC) 630, CU control plane (CU-CP) 624, CU user plane (CU-UP) 626, and Distributed Unit (DU) 621. In one embodiment, the software-level components may be run using a dedicated hardware server. In another embodiment, the software-level components may be run using a virtual machine running or containerized environment running on the set of machines. In another embodiment, the software-level components may be run from the cloud (e.g., the software-level components may be deployed using a cloud-based compute and storage infrastructure).

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMS, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A computing system for adjusting network parameters in a wireless communication network, wherein the computing system comprises:
one or more processing devices; and
memory communicatively coupled with and readable by the one or more processing devices and having stored therein processor-readable instructions which, when executed by the one or more processing devices, cause the one or more processing devices to perform operations comprising:
executing a machine learning model on the computing system, wherein the computing system operates on a centralized node of a wireless communication network;
monitoring, using the machine learning model, user plane network traffic associated with a user plane tunnel in the wireless communication network;
detecting, using the machine learning model, an occurrence of one or more conditions in the user plane network traffic indicative of one or more network issues; and
adjusting one or more network parameters of the wireless communication network based on detecting the occurrence of the one or more conditions in the user plane network traffic.

2. The computing system of claim 1, wherein the user plane network traffic is real-time general packet radio service (GPRS) tunneling protocol (GTP) user plane function (GTP-U) network traffic.

3. The computing system of claim 1, wherein the operations further comprise:
analyzing, using the machine learning model, training data indicative of historical user plane network traffic associated with the user plane tunnel in the wireless communication network; and
identifying, using the machine learning model, the one or more conditions in the historical user plane network traffic.

4. The computing system of claim 3, wherein analyzing the training data comprises analyzing at least one of a traffic volume, a packet loss rate, a latency, or a quality of service associated with the historical user plane network traffic.

5. The computing system of claim 1, wherein detecting the occurrence of the one or more conditions in the user plane network traffic comprises detecting at least one of an increase in traffic volume, an increase in a packet loss rate, an increase in latency, or a decrease in a quality of service in the user plane network traffic.

6. The computing system of claim 1, wherein adjusting the one or more network parameters comprises at least one of adjusting a timer associated with the user plane tunnel, adjusting a threshold associated with the user plane tunnel, allocating one or more resources to the user plane tunnel, performing a load balancing for the user plane network traffic, or re-routing the user plane network traffic to another user plane tunnel.

7. The computing system of claim 6, wherein adjusting the timer associated with the user plane tunnel comprises adjusting at least one of a re-transmission timer, a timeout timer, or a re-transmission timeout timer associated with the user plane tunnel, and wherein adjusting the threshold associated with the user plane tunnel comprises adjusting at least one of a congestion threshold or a maximum quantity of permitted re-transmissions associated with the user plane tunnel.

8. The computing system of claim 1, wherein adjusting the one or more network parameters comprises adjusting at least one of a network policy, a network configuration, or a quality of service requirement associated with the user plane tunnel.

9. The computing system of claim 1, wherein the operations further comprise generating, using the machine learning model, an output value that indicates at least one of a packet loss rate, a latency, a throughput, an average traffic volume, a peak usage time period, or a frequency of performance degradation events associated with the user plane network traffic, wherein the output value is an average value or a standard deviation value.

10. A method of operating a computing system for adjusting network parameters in a wireless communication network, wherein the method comprises:
executing a machine learning model on the computing system, wherein the computing system operates on a centralized node of the wireless communication network;
monitoring, using the machine learning model, user plane network traffic associated with a user plane tunnel in the wireless communication network;
detecting, using the machine learning model, an occurrence of one or more conditions in the user plane network traffic indicative of one or more network issues; and
adjusting, by the computing system, one or more network parameters of the wireless communication network based on detecting the occurrence of the one or more conditions in the user plane network traffic.

11. The method of claim 10, wherein the user plane network traffic is real-time general packet radio service (GPRS) tunneling protocol (GTP) user plane function (GTP-U) network traffic.

12. The method of claim 10, further comprising:
analyzing, using the machine learning model, training data indicative of historical user plane network traffic associated with the user plane tunnel in the wireless communication network; and
identifying, using the machine learning model, the one or more conditions in the historical user plane network traffic.

13. The method of claim 12, wherein analyzing the training data comprises analyzing at least one of a traffic volume, a packet loss rate, a latency, or a quality of service associated with the historical user plane network traffic.

14. The method of claim 10, wherein detecting the occurrence of the one or more conditions in the user plane network traffic comprises detecting at least one of an increase in traffic volume, an increase in a packet loss rate, an increase in latency, or a decrease in a quality of service in the user plane network traffic.

15. The method of claim 10, wherein adjusting the one or more network parameters comprises at least one of adjusting a timer associated with the user plane tunnel, adjusting a threshold associated with the user plane tunnel, allocating one or more resources to the user plane tunnel, performing a load balancing for the user plane network traffic, or re-routing the user plane network traffic to another user plane tunnel.

16. The method of claim 10, further comprising generating, using the machine learning model, an output value that indicates at least one of a packet loss rate, a latency, a throughput, an average traffic volume, a peak usage time period, or a frequency of performance degradation events associated with the user plane network traffic, wherein the output value is an average value or a standard deviation value.

17. One or more non-transitory, computer-readable storage media having computer-readable instructions thereon which, when executed by one or more processing devices, cause the one or more processing devices to perform operations comprising:
executing a machine learning model on a computing system, wherein the computing system operates on a centralized node of a wireless communication network;
monitoring, using the machine learning model, user plane network traffic associated with a user plane tunnel in the wireless communication network;
detecting, using the machine learning model, an occurrence of one or more conditions in the user plane network traffic indicative of one or more network issues; and
adjusting, by the computing system, one or more network parameters of the wireless communication network based on detecting the occurrence of the one or more conditions in the user plane network traffic.

18. The one or more non-transitory, computer-readable storage media of claim 17, wherein the user plane network traffic is real-time general packet radio service (GPRS) tunneling protocol (GTP) user plane function (GTP-U) network traffic.

19. The one or more non-transitory, computer-readable storage media of claim 17, wherein the computer-readable instructions, when executed by the one or more processing devices, further cause the one or more processing devices to perform operations comprising:
analyzing, using the machine learning model, training data indicative of historical user plane network traffic associated with the user plane tunnel in the wireless communication network; and
identifying, using the machine learning model, the one or more conditions in the historical user plane network traffic.

20. The one or more non-transitory, computer-readable storage media of claim 19, wherein analyzing the training data comprises analyzing at least one of a traffic volume, a packet loss rate, a latency, or a quality of service associated with the historical user plane network traffic, and wherein detecting the occurrence of the one or more conditions in the user plane network traffic comprises detecting at least one of an increase in the traffic volume, an increase in the packet loss rate, an increase in the latency, or a decrease in the quality of service in the user plane network traffic.
